(19) United States
(12) Patent Application Publication
(10) Pub. No.: US 2023/0173525 A1
(43) Pub. Date: Jun. 8, 2023

(54) SYSTEM AND METHOD FOR REMOVING SCALE OF SEWER PIPE USING MICROBIAL MIST TYPE SPRAY

(71) Applicant: Bong-hwan KIM, Daejeon (KR)

(72) Inventor: Bong-hwan KIM, Daejeon (KR)

(21) Appl. No.: 16/966,761

(22) PCT Filed: Jun. 22, 2020
(86) PCT No.: PCT/KR2020/008056

§ 371 Date: Jul. 31, 2020

(30) Foreign Application Priority Data
Jun. 19, 2020 (KR) 10-2020-0074854

(51) Int. Cl. B05B 13/06; B05B 7/24; E03F 9/00; B08B 9/032

(52) U.S. Cl. CPC B05B 13/0627; B05B 7/2491; E03F 9/002; B08B 9/032

(57) ABSTRACT

System and method for removing scale of a sewer pipe using microbial mist type spray, the system including a microbe storage tank to store liquid microbes; a chamber connected with the microbe storage tank through an injection pipe and supplied with a determined, metered amount of liquid microbes, if needing to spray liquid microbes into the sewer pipe; a metering pump provided on one side of the injection pipe, to supply power for injecting a metered amount of liquid microbes into the chamber; an air tank to store compressed air; a supply pipe to supply compressed air into the chamber when the liquid microbes are sprayed; a supply tube to allow liquid microbes having air cavities resulting from supply of the compressed air to flow; and a spray nozzle provided at an end of the supply tube, to spray liquid microbes in a mist form into the sewer pipe.

### CROSS-REFERENCE TO RELATED APPLICATIONS

This application is the U.S. National Phase of, and Applicant claims priority from, International Patent Application No. PCT/KR2020/008056, filed on 22 Jun. 2020, and Korean Patent Application No. KR 10-2020-0074854, filed on 19 Jun. 2020, the contents of both of which are incorporated herein by reference in their entirety.

### BACKGROUND

### Technical Field

The present disclosure is related to a system and method for removing the scale of a sewer pipe using microbial mist type spray.

### Related Art

Sludge deposited inside a pipeline causes ill-smelling pipeline blockages that often occur due to lipid components, resulting in clogged drain problems.

It is a well-known method that a separate device is inserted into the clogged pipeline from the exterior so as to solve such a problem. This often causes a rupture to the pipeline by over-insertion of such a device into the pipeline and has a limit to removing the deposited sludge or lipid components completely, thus incurring pipeline clogging again following the passage of a certain period of time.

In order to avoid repeating such a phenomenon of pipeline clogging, there are required cumbersome processes of plumbing replacement involving interior renovations, which may cause inconveniences to a downstairs neighbor.

As an alternative to the previously mentioned problems, there was developed a method for removing impurities by injecting acidic or alkaline cleaning liquid or microbes into the pipeline or using a high-pressure water jet. However, since the lipid components included in the sludge floated on the surface of the sludge due to their own property thus forming scale, the injected cleansing liquid such as water merely reacted with the scale formed in the lower portion of the pipeline but failed to remove the scale floating on the upper portion thereof.

Therefore, there have been demands for a device that is set up everywhere a pipeline is exposed in a building, causing no conflict between upstairs and downstairs neighbors and also capable of removing even the scale in the upper portion of the pipeline, thus restoring the condition of the pipeline.

In particular, in order to solve sewer blockages caused by domestic sewage or food waste leachate in a sewer line of the building in an environmentally friendly manner, there have been demands for a device and method that allow effectively injecting the existing liquid type microbes into the sewer line while increasing application areas thereof for the scale.

Further, sewer line deposition is characterized in that lipid components in the sewage flowing in the sewer line are lighter than water, thus being deposited in the upper portion of the sewer line. Accordingly, since the existing cleansing liquid flows to the downstream of the sewer line along with water, without reacting with the scale of the upper portion, a large amount of cleansing liquid is required to be injected into the sewer line in order to show cleaning effects.

Further, in a case of feeding facilities, alkaline cleansers are commonly used in cleaning, thus creating a pH condition that is too hostile for the microbes to show effects inside the sewer line.

In addition, if the existing liquid microbes are injected directly into the sewer line, they flow to the bottom thereof, thus failing to be applied to the scale in the upper portion of the sewer line.

Accordingly, if sewage flows in during the growth of liquid microbes from the lower portion of a sewer pipe to the upper portion thereof, the microbes are swept away without growth. Thus, the liquid microbes are needed to be applied directly to the scale in the upper portion of the sewer pipe so as to allow the liquid microbes to show removing effects on the scale in the upper portion of the sewer pipe.

### SUMMARY

### Technical Problem

Therefore, the present disclosure is provided to solve conventional problems as described above. In an embodiment in accordance with the present disclosure, there are provided a system and method for removing the scale of a sewer pipe using microbial mist type spray, spraying microbes in a state of mist to the common sewer pipe used in apartments or shopping centers, thus applying the microbes to the scale of the sewer pipe, particularly to that of the upper portion, wherein potentiating microbial effects appear rapidly as compared with direct injection of such liquid microbes into the sewer pipe.

Further, in another embodiment in accordance with the present disclosure, there are provided a system and method for removing the scale of a sewer pipe using microbial mist type spray, supplying a metered amount of liquid microbial cleanser to a position needing to spray the same in a chamber using a metering pump, then supplying compressed air thus forming air cavities between the liquid microbes and allowing the same to be in a mist-form, thus allowing the spraying or applying the liquid microbes to a wide area.

Further, in yet another embodiment in accordance with the present disclosure, there are provided a system and method for removing the scale of a sewer pipe using microbial mist type spray, allowing injecting the liquid microbes in a metered amount using a chamber and compressed air regardless of a distance between the device and the sewer pipe, which push the liquid microbes in the chamber out with the compressed air, thus forming microbial bubbles and air cavities in a supply tube according to changes in atmospheric pressure, which allows the microbial bubbles to be in a mist-form as if bursting, thus applying the liquid microbes to the wide area when being sprayed from a needle type nozzle.

Meanwhile, technical objects to be achieved in the present disclosure are not limited to the aforementioned technical objects, and other technical objects, which are not mentioned above, will be apparently understood to a person having ordinary skill in the art from the following description.

### Technical Solution

According to a first aspect of the present disclosure, a system for removing the scale of a sewer pipe using microbial mist type spray is provided. The system may include: a microbe storage tank that stores liquid microbes; a chamber that is connected with the microbe storage tank through an injection pipe and is supplied with a determined, metered amount of liquid microbes, if needing to spray liquid microbes into the sewer pipe; a metering pump that is provided on one side of the injection pipe, thus supplying power for injecting a metered amount of liquid microbes into the chamber; a compressed air tank that stores compressed air; a compressed air supply pipe that supplies compressed air into the chamber when the liquid microbes are sprayed; a supply tube that allows the liquid microbes having air cavities resulting from supplying the compressed air to flow; and a spray nozzle that is provided at an end of the supply tube, thus spraying liquid microbes in a mist-form into the sewer pipe.

According to another aspect of the present disclosure, the system for removing the scale of a sewer pipe using microbial mist type spray is characterized by further including a flow controller that is provided between the chamber and the supply tube, wherein the flow controller is provided with a plurality of control valves being in a row and the supply tube is connected with the respective control valves.

According to another aspect of the present disclosure, the system for removing the scale of a sewer pipe using microbial mist type spray is characterized by forming microbial bubbles and air cavities in the supply tube according to changes in atmospheric pressure, while pressurizing liquid microbes in the chamber with the compressed air.

According to another aspect of the present disclosure, the system for removing the scale of a sewer pipe using microbial mist type spray is characterized in that the spray nozzle consists of a needle type nozzle and an adaptor for fixing a needle to a pipeline, thus perforating the pipeline to the extent of the needle's thickness at the least, minimizing damages on the pipeline and water leak, and microbial bubbles becoming in a mist-form then being sprayed and applied into the sewer pipe when liquid microbes are sprayed.

According to another aspect of the present disclosure, the system for removing the scale of a sewer pipe using microbial mist type spray is characterized by further including: a compressor that supplies compressed air into the compressed air tank by being driven; and a supply valve which is provided on one side of the compressed air supply pipe.

According to another aspect of the present disclosure, the system for removing the scale of a sewer pipe using microbial mist spray is characterized by further including a controller that controls the metering pump, the control valve, the compressor, and the supply valve.

According to a second aspect of the present disclosure, a method for removing the scale of a sewer pipe using microbial mist type spray is provided. The method may include: determining a position of a sewer pipe needing to remove scale and metered amount of liquid microbes to be applied; supplying a determined, metered amount of liquid microbes into a chamber in a microbe storage tank, by driving a metering pump; supplying compressed air in a compressed air tank into the chamber by opening a supply valve; supplying a supply tube with liquid microbes in a state that air cavities are formed according changes in atmospheric pressure resulted from supplying compressed air by opening control valve that is connected with a supply tube equipped to a determined position of a sewer pipe; and spraying liquid microbes becoming in a mist-form by a needle type nozzle at an end of the supply tube.

### Advantageous Effects

According to the present disclosure, there are provided a system and method for removing the scale of a sewer pipe using microbial mist type spray, spraying microbes in a state of mist to the common sewer pipe used in apartments or shopping centers, thus applying the microbes to the scale of the sewer pipe, particularly to that of the upper portion, wherein potentiating microbial effects appear rapidly as compared with direct injection of such liquid microbes into the sewer pipe.

Further, according to the present disclosure, there are provided a system and method for removing the scale of a sewer pipe using microbial mist type spray, supplying a metered amount of liquid microbial cleanser to a position needing to spray the same in a chamber using a metering pump then supplying compressed air, thus forming air cavities between the liquid microbes and allowing the same to be in a mist-form, thus allowing the spraying or applying the liquid microbes to a wide area.

Further, according to the present disclosure, there are provided a system and method for removing the scale of a sewer pipe using microbial mist type spray, allowing injecting the liquid microbes in a metered amount using a chamber and compressed air regardless of a distance between the device and the sewer pipe, which push the liquid microbes in the chamber out with the compressed air, thus forming microbial bubbles and air cavities in a supply tube according to changes in atmospheric pressure, allowing the microbial bubbles to be in a mist-form as if bursting, thus applying the liquid microbes to the wide area when being sprayed from a needle type nozzle.

Meanwhile, advantageous effects to be obtained in the present disclosure are not limited to the aforementioned effects, and other effects, which are not mentioned above, will be apparently understood to a person having ordinary skill in the art from the following description.

### BRIEF DESCRIPTION OF THE DRAWINGS

The accompanying drawings of this specification exemplify a preferred embodiment of the present disclosure, the scope of the present disclosure will be more clearly understood from the following detailed description taken in conjunction with the accompanying drawings, and thus it will be understood that the present disclosure is not limited to only contents illustrated in the accompanying drawings.

FIG. 1 is a flowchart showing a method for removing the scale of a sewer pipe using microbial mist type spray according to an embodiment of the present disclosure.

FIG. 2 is a configuration view of a system for removing the scale of a sewer pipe using microbial mist type spray according to an embodiment of the present disclosure.

FIG. 3 is a schematic view of a cross-section of a sewer pipe into which liquid microbes are sprayed by a needle type nozzle according to an embodiment of the present disclosure.

FIG. 4 is a block diagram showing signal flow of a controller according to an embodiment of the present disclosure.

### REFERENCE NUMBERS

1: Sewer pipe 10: Chamber 11: Connection pipe
20: Microbe storage tank 21: Injection pipe 30: Metering pump
40: Compressed air tank 41: Supply pipe 42: Supply valve
43: Compressor 50: Flow controller 51: Control valve
60: Supply tube 61: Needle type nozzle and fixing adaptor
70: Controller 100: System for removing the scale of a sewer pipe using microbial mist type spray

### DETAILED DESCRIPTION

Best Mode

The accompanying drawings of this specification exemplify a preferred embodiment of the present disclosure, with the scope of the present disclosure more clearly understood from the following detailed description taken in conjunction with the accompanying drawings, and thus it will be understood that the present disclosure is not limited to only contents illustrated in the accompanying drawings.

Hereinafter, in accordance with the present disclosure, there are described the configuration and function of a system for removing the scale of a sewer pipe using microbial mist type spray and a method thereof.

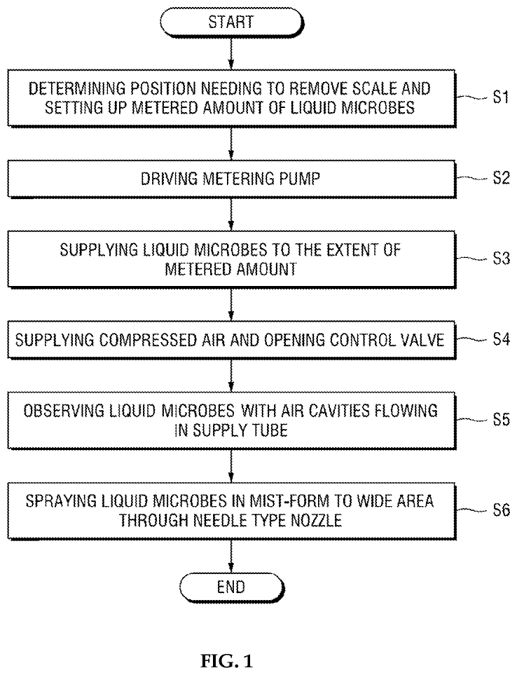

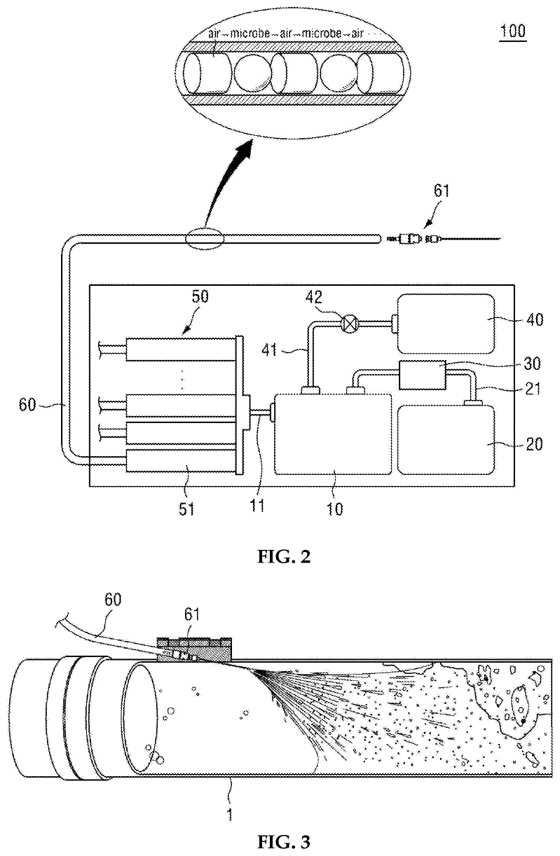

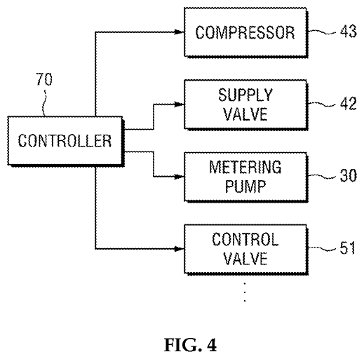

Firstly, FIG. 1 is a flowchart showing a method for removing the scale of a sewer pipe using microbial mist type spray according to an embodiment of the present disclosure. FIG. 2 is a configuration view of a system for removing the scale of a sewer pipe using microbial mist type spray according to an embodiment of the present disclosure. Further, FIG. 3 is a schematic view of a cross-section of a sewer pipe into which liquid microbes are sprayed by a needle type nozzle according to an embodiment of the present disclosure. Further, FIG. 4 is a block diagram showing signal flow of a controller according to the embodiment of the present disclosure.

A system 100 for removing the scale of a sewer pipe using microbial mist type spray, as shown in FIG. 2, may be configured to include a chamber 10, a microbe storage tank 20, a metering pump 30, a compressed air tank 40, a flow controller 50, a needle type nozzle 61, etcetera.

Liquid microbes are stored inside the microbe storage tank 20.

The chamber 10 according to the embodiment of the present disclosure is connected with the microbe storage tank 20 through an injection pipe 21, and is configured to be supplied with liquid microbes to the extent of the determined, metered amount, if needing to spray liquid microbes into a sewer pipe 1.

That is, in a case that the liquid microbes are sprayed into the sewer pipe 1 needing to remove scale, the amount of the liquid microbes required therefor is metered and determined, and a metered amount of the liquid microbes is then injected into the chamber 10 by driving the metering pump 30.

Moreover, in the case that the liquid microbes are sprayed, compressed air is stored in the compressed air tank 40. The compressed air storage tank 40 may be configured to be coupled with a compressor 43 thus being supplied with and storing the compressed air resulting from driving the compressor 43.

When the liquid microbes are sprayed, the compressed air is supplied into the chamber 10, thus the liquid microbes in the chamber 10 are supplied into a supply tube 60 by pressurization.

At this time, the supply tube 60, as shown in a partial enlarged view of FIG. Z allows the liquid microbes having air cavities resulting from supplying the compressed air to flow. That is, the liquid microbes in the chamber 10 are pressurized with the compressed air, thus microbial bubbles and air cavities are formed in the supply tube 60 according to changes in atmospheric pressure.

Firstly, if the compressed air is supplied into the chamber 10, the liquid microbes are discharged through a connection pipe 11, then passing through a flow controller 50, and being supplied to the supply tube 60.

This flow controller 50 is provided with a plurality of control valves 51 being in a row and the supply tube 60 is connected with the respective control valves 51. These control valves 51 may consist of solenoid valves and it is allowable to separately spray the liquid microbes to households' sewer pipe 1 jointly used in apartments or shopping centers or to the sewer pipe 1 used in each store, by adding the solenoid valves to be connected to the chamber 1.

Moreover, a spray nozzle is connected to an end of the supply tube 60, and the spray nozzle according to the embodiment of the present disclosure consists of a needle type nozzle and a fixing adaptor 61.

Therefore, as the spray nozzle consists of the needle type nozzle and the fixing adaptor 61, when the liquid microbes are sprayed, the microbial bubbles become in a mist-form as if bursting, thus being sprayed and applied to the wide area, i.e., to an upper inner side of the sewer pipe 1.

A controller 70 in accordance with the system 100 for removing the scale of a sewer pipe using microbial mist type spray according to the embodiment of the present disclosure controls overall the aforementioned metering pump 30, the control valve 51, the compressor 43. and the supply valve 42.

### DESCRIPTION OF EMBODIMENTS

Herein after, there is described a method for removing the scale of a sewer pipe using the aforementioned system 100 for removing the scale of a sewer pipe using microbial mist type spray.

Firstly, there are checked the amount of microbes stored in the microbe storage tank 20, the amount of the compressed air in the compressed air tank 40 resulting from driving the compressor 43, and pressures.

Moreover, there are determined a position of the sewer pipe 1 needing to remove scale, and the metered amount of liquid microbes to be applied (S1).

The controller 70 drives the metering pump 30 (S2), thus controlling the liquid microbes 20 to be supplied to the extent of the determined, metered amount from the microbe storage tank 20 to the chamber 10 (S3).

When a metered amount of the liquid microbes is supplied into the chamber 10, the metering pump 30 is suspended from being driven and the compressed air in the compressed air tank 40 is supplied into the chamber 10 by opening the supply valve 42.

Furthermore, there is opened the control valve 51 connected with the supply tube 60 equipped to the determined position of the sewer pipe 1, thus supplying the supply tube 60 with liquid microbes in a state that air cavities are formed according changes in atmospheric pressure resulted from supplying compressed air (54).

The liquid microbes become in a mist-form as if bursting by using the needle type nozzle and the fixing adaptor 61 at the end of the supply tube 60, thus being sprayed into the sewer pipe 1 (S5). When the liquid microbes are sprayed, the microbial bubbles become in a mist-form as if bursting by using the needle type nozzle 61, thus being sprayed and applied to the wide area, i.e., to an upper inner side of the sewer pipe 1.

Therefore, the system 100 and method for removing the scale of a sewer pipe by microbial mist type spray according to the aforementioned embodiment of the present disclosure are capable of injecting a metered amount of the liquid microbes using the chamber 10 and the compressed air, regardless of a distance between the device and the sewer pipe 1, forming the microbial bubbles and the air cavities in the supply tube 60 by pushing the liquid microbes in the chamber 10 out with the compressed air, and allowing the microbial bubbles being in a mist-form as if bursting, thus being sprayed and applied to the wide area.

Further, the system and method as described above are not limited to the configuration and method of the above described embodiments, but may be configured by selectively combining the whole or parts of the respective embodiments, so as to achieve various modifications.

1. A system for removing scale of a sewer pipe using microbial mist type spray, the system comprising:
a microbe storage tank configured to store liquid microbes;
a chamber connected with the microbe storage tank through an injection pipe and supplied with a determined, metered amount of liquid microbes, when needed to spray the metered amount of liquid microbes into the sewer pipe;
a metering pump provided on one side of the injection pipe, the metering pump configured to supply power for injecting the metered amount of liquid microbes into the chamber;
a compressed air tank configured to store compressed air;
a compressed air supply pipe configured to supply compressed air into the chamber when the metered amount of liquid microbes is sprayed;
a supply tube configured to allow liquid microbes having air cavities resulting from supplying the compressed air to flow; and
a spray nozzle provided at an end of the supply tube configured to spray liquid microbes in a mist-form into the sewer pipe.

2. The system for removing scale of a sewer pipe using microbial mist type spray according to claim 1, wherein the system further comprises a flow controller provided between the chamber and the supply tube, the flow controller provided with a plurality of control valves being in a row and the supply tube connected with the respective control valves.

3. The system for removing scale of a sewer pipe using microbial mist type spray according to claim 2, wherein microbial bubbles and air cavities are formed in the supply tube according to changes in atmospheric pressure while pressurizing liquid microbes in the chamber with the compressed air.

4. The system for removing scale of a sewer pipe using microbial mist type spray according to claim 3, wherein the spray nozzle consists of a needle type nozzle and an adaptor for fixing a needle to a pipeline, thus perforating the pipeline at least to the extent of needle's thickness, minimizing damages to the pipeline and water leak, and forming microbial bubbles in a mist-form then being sprayed and applied into the sewer pipe when liquid microbes are sprayed.

5. The system for removing scale of a sewer pipe using microbial mist type spray according to claim 4, wherein the system further comprises:
a compressor configured to supply compressed air into the compressed air tank by being driven; and
a supply valve provided on one side of the compressed air supply pipe.

6. The system for removing scale of a sewer pipe using microbial mist type spray according to claim 5 wherein the system further comprises a controller configured to control the metering pump, the control valve, the compressor, and the supply valve.

7. A method of removing scale of a sewer pipe using microbial mist type spray, the method comprising:
determining a position of a sewer pipe needing to remove scale and metered amount of liquid microbes to be applied;
supplying a determined, metered amount of liquid microbes into a chamber in a microbe storage tank, by driving a metering pump;
supplying compressed air in a compressed air tank into the chamber by opening a supply valve;
supplying a supply tube with liquid microbes in a state that air cavities are formed according to changes in atmospheric pressure resulting from supplying compressed air by opening a control valve connected with a supply tube equipped to a determined position of a sewer pipe; and
spraying liquid microbes formed into a mist-form using a needle type nozzle at an end of the supply tube.
